(19) United States
(12) Patent Application Publication
(10) Pub. No.: US 2026/0218777 A1
(43) Pub. Date: Jul. 30, 2026

(54) SHACKLES

(71) Applicant: International Safety Components Ltd, Bangor, Gwynedd (GB)

(72) Inventors: Kevin Brown, Bangor, Gwynedd (GB); Daniel John Yates, Bangor, Gwynedd (GB)

(21) Appl. No.: 19/144,856

(22) PCT Filed: Feb. 27, 2024
(86) PCT No.: PCT/GB2024/000010

§ 371 Date: Jun. 30, 2025

(30) Foreign Application Priority Data
Dec. 28, 2022 (GB) 2219775.0
Apr. 6, 2023 (GB) 2305159.2

(51) Int. Cl. F16G 15/06

(52) U.S. Cl. CPC F16G 15/06

(57) ABSTRACT

Shackle (1) having a yoke with a pair of first and second yoke arms (2,3) with respective first and second co-axial bores (13,12) between which are disposed a shackle pin (4), the shackle pin having a flanged first end (5) to limit axial movement through the first bore (13), the shackle including locking means whereby to prevent accidental release of the shackle pin from the yoke arms, a guide element (6) extending into the shackle pin receiving bore of the first yoke arm and being received in a common groove (10) in the outer surface of the shackle pin, wherein, extending axially from the second end of the shackle pin (4), are key formations (11) co-operable with a keyhole formation (12a) at the end of the bore (12) in the second yoke arm (3).

This invention relates to shackles of the type that are often in the form of a “U” shaped yoke having a pair of yoke arms between the ends of which are received a removable shackle pin, although it will be understood that the invention extends to shackles of other shape, including fixed shackles where the yoke arms extend from a base which itself serves another function, such as being part of a wheeled vehicle or marine vessel.

### BACKGROUND OF THE INVENTION

Shackles have many uses including for lifting and lowering loads, connecting chain links, and for tensioning rigging ropes or wires in sailing vessels such as yachts with the aid of turnbuckles. At its simplest, the shackle includes a pair of yoke arms for receiving therebetween through a pair of co-axial bores a shackle pin with a flanged first end and a second end with a cross-bore through which is inserted a split pin which can then be deformed to ensure that the shackle pin is securely retained between the yoke arms. However, it will be understood that such a simple arrangement has the disadvantage in that during assembly or disassembly the shackle pin and/or the split pin may become lost, particularly where weather conditions are adverse and fingers are numb through cold. In addition, tools such as pliers are required to initially deform the split pin or to straighten it when it is necessary to remove the shackle pin, and such tools can easily be dropped, therefore potentially causing a hazard when working at height.

An example of an improved type of shackle can be found in U.S. Pat. No. 1,419,974 dating from 1921 in which a shackle pin is permanently retained on one of the arms of a metal yoke by a locking element which extends radially outwardly from the free end of the shackle pin and is received within a correspondingly shaped recess in one of the arms of the yoke. That yoke arm also includes a groove opposite the recess which extends across the entire width of the arm, effectively acting as a keyhole permitting the locking element to be removed from a locked position to a position in which it can slide freely therethrough to thereby enable the shackle pin to be withdrawn to the limit imposed by the presence of the opposing yoke arm, in which a corresponding recess is provided for receiving the locking element, the recess having a closed end preventing the shackle pin from becoming completely detached from the shackle yoke. A disadvantage of this arrangement is the presence of the keyhole groove extending through all of the yoke arms as well as the two recesses for receiving the locking element, which collectively weakens the shackle, making it potentially unsuitable for use in high tensile applications unless the yoke arms are thickened in order to compensate for the loss of metal. In addition, machining of the relatively complicated shape of the two recesses for receiving the locking element can be difficult in order to form a shape corresponding to the operational part of the locking element.

An improved type of shackle is shown in WO2021/194354 in which relatively little material is removed from one of the yoke arms, this material being removed to form a circular groove for receiving the rim of a cylindrical housing for a spring-biased quick-release locking mechanism in which a series of ball-bearings are releasably captured by a circular groove near to the free end of a flanged shackle pin, the arrangement being such that when the housing is retracted against the bias of the spring the ball-bearings are released from the groove, enabling the housing and its contents, including the ball-bearings, to be disconnected from the shackle pin. In order to initially mount the quick-release locking mechanism onto the end of the shackle pin it is simply necessary to push-fit it until the ball-bearings are again received within the circular groove. This arrangement is extremely convenient in providing a quick-release shackle pin but has the disadvantage in that the pin can become lost, although this disadvantage is addressed in the embodiment described with reference to FIGS. 5 & 6 of that disclosure in which a “tension pin” 150 is co-operable with a shoulder 217 at the end of the shackle pin 216 to prevent complete removal of the shackle pin from the arms of the shackle. However, this is a relatively complicated arrangement where it is still possible for the tension pin 152 to become lost, and in both embodiments of the invention the interior of the quick-release mechanism with its various moving parts may be susceptible to damage or blockage due to dust or debris. A further disadvantage is that the housing for the quick release mechanism protrudes significantly from the end of the shackle pin and can therefore be a snagging hazard in use.

In CN204661203U there is disclosed an arrangement in which the shackle pin of a shackle is received in respective through-bores at the ends of each yoke arm and includes a flanged first end to limit its extent of travel through the bores, complete removal of the shackle pin being prevented by means of a common groove in the shackle pin being co-operable with a guide element in the form of a spring-loaded locking pin extending from the yoke arm adjacent the flanged end of the pin, the common groove having a short arcuate portion near the flanged end of the shackle pin with a closed first end with a first bore for receiving the locking pin, the common groove extending along the major axis of the shackle pin to a closed second end with a second bore also for receiving the locking pin, the arrangement being such that when the shackle pin is fully received in the bores of both yoke arms it can be releasably locked in position by means of the locking pin being received in the first bore at the end of the arcuate portion, and when the locking pin is removed from the first bore against the spring bias, the shackle pin can be rotated about its major axis until the locking pin is in alignment with the common groove along the major axis of the shackle pin, thereby allowing the shackle pin to be withdrawn up to the limit imposed by the closed end of the common groove, whereafter it can be releasably locked in position by the locking pin being received in the second bore. Although this arrangement provides a shackle that can be locked and unlocked easily without the need for any tools it has the disadvantage in that because the free end of the shackle pin remote from its flanged end is not locked to its respective yoke arm it follows that when the shackle pin is under tensile load there is a tendency for it to bend and, in doing so, to slide out of its respective bore in the yoke arm, which itself may splay outwardly as a consequence, potentially leading to catastrophic failure unless the yoke arms and the shackle pin are fit enough to counteract the effects of tensile bending. Additionally, removal of material from the shackle pin to provide a pair of bores for receiving the locking pin necessarily weakens it. Such a shackle is therefore unsuitable for use where light weight is considered desirable, such as shackles for use in the sport of mountaineering.

The present invention is derived from the realisation that there is a need for an improved shackle in which the foregoing disadvantages are obviated.

### SUMMARY OF THE INVENTION

According to the invention there is provided a shackle having a yoke with a pair of first and second yoke arms with respective first and second co-axial bores between which are disposed a shackle pin, the shackle pin having a flanged first end to limit axial movement through the first bore, the shackle including locking means whereby to prevent accidental release of the shackle pin from the yoke arms, a guide element extending into the shackle pin receiving bore of the first yoke arm and being received in a common groove in the outer surface of the shackle pin, the common groove having an arcuate portion with a closed first end adjacent the first end of the shackle pin, the common groove continuing radially from the closed first end to a corner portion and thereafter continuing along the major length of the shackle pin to a closed second end adjacent the second end of the shackle pin, the second end of the shackle pin being receivable in the corresponding bore of the second yoke arm, CHARACTERISED IN THAT extending axially from the second end of the shackle pin are key formations co-operable with a keyhole formation at the end of the bore in the second yoke arm whereby to prevent withdrawal of the shackle pin from the bore in the second yoke arm when the shackle pin has been rotated about its major axis such that the key formations lie behind the keyhole formation.

With this arrangement, if the shackle is subjected to intense tensile loading which could otherwise cause the yoke arms to bend outwardly away from each other, thereby allowing the free end of the shackle pin to escape its respective bore, or for the shackle pin itself to bend under tensile load with the same ultimate result, this is prevented because each end of the shackle pin is effectively locked to a respective yoke arm. Thus, by effectively locking the shackle pin to both arms of the yoke the shackle in its entirety becomes, in effect, a single link which, if used to connect e.g. two chains, will only distort under excessive tensile load rather than the shackle pin separating from one of the yoke arms.

Most of the material removed from the shackle in order to facilitate a locking means that is not only simple to operate but also prevents the shackle pin from being accidentally lost, is taken from the shackle pin itself by virtue of the presence of the key formation at the second end and the common groove, which need only be a shallow groove since its only function is to receive the guide element, the guide element itself serving to prevent complete withdrawal of the shackle pin from the first yoke arm. However, even if this small loss of material is considered structurally significant the diameter of the shackle pin can be proportionally increased if considered necessary. This arrangement means that little material has to be removed from the first yoke arm in order to allow a locking element, such as a detente ball or pin, to project into the bore for receiving the shackle pin to the extent necessary to engage in the common groove to limit movement of the shackle pin and ensure that it can never become detached from the first yoke arm.

Conveniently, the detente part of the guide element comprises a ball, such as a steel ball-bearing, which may simply partly protrude into the coaxial bore in the first yoke arm, or it may be biased by spring-means, such as a helically wound spring, to remain in the shackle pin common groove.

Preferably, the arcuate part of the common groove in the shackle pin is of length sufficient to ensure that when the detente guide element is engaged at the closed end of the common groove the axially extending part of the groove is always pointing away from the yoke and, ideally, the arcuate part is of length corresponding to an approximately 90° rotation of the pin about its major axis. With this arrangement the shackle pin can therefore also serve to function as an axle for a pulley wheel mounted thereon where tensile loads on the pulley wheel are therefore only transmitted to that part of the shackle pin generally opposite the axial part of the common groove acting as a bearing surface in the manner of an axle. When used in this configuration, the major part of the common groove may therefore serve to retain a lubricant such as grease which is thereafter gradually dispensed over the relevant bearing surfaces automatically as the pulley wheel rotates until replenishment is required. Accordingly, the invention also extends to the combination of a pulley wheel mounted on the shackle pin to collectively define with the rest of the shackle a pulley.

### BRIEF DESCRIPTION OF THE DRAWINGS

The invention will now be described, by way of example only, with reference to the accompanying drawings in which:

FIG. 1 is a plan view of a shackle according to the invention,

FIG. 2 is a perspective view from the front and one side of the shackle of FIG. 1,

FIG. 3 is a perspective rear view from the other side of the shackle of FIG. 1,

FIG. 4 is a perspective view from one side and the front of the shackle of FIG. 1,

FIG. 5 is a perspective view from the other side and the rear of the shackle FIG. 1,

FIG. 6 is an exploded view of the shackle of FIG. 1,

FIG. 7 is a perspective view corresponding to that shown in FIG. 4 of a first version of a preferred embodiment, and

FIG. 8 is a perspective view of a second version of a preferred embodiment.

In this patent specification, the term “shackle” is intended to refer to any arrangement in which a pair of spaced-apart yoke arms are supported by a base, with each yoke arm having a bore for receiving therebetween part or all of a common shackle pin. The base can be integral with the yoke arms or may be separate, such as by being part of the structure of a wheeled vehicle or a marine vessel.

### DETAILED DESCRIPTION OF THE DRAWINGS

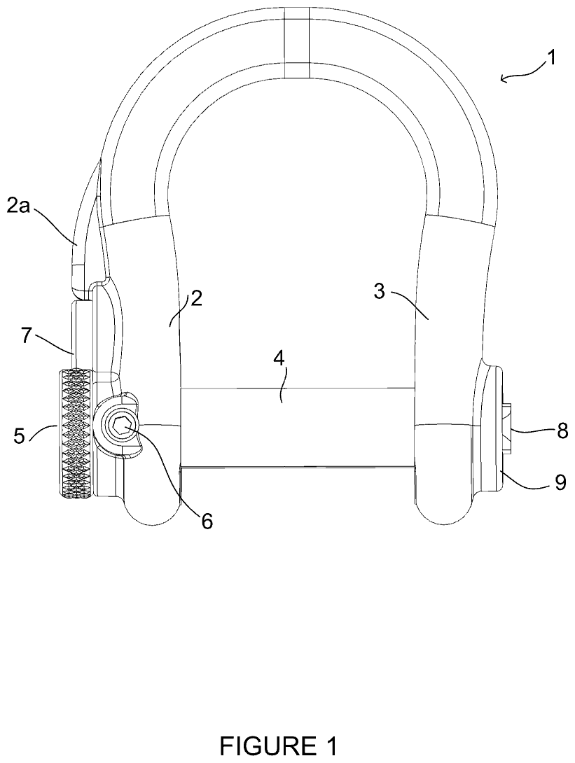

FIG. 1 is a plan view of a shackle 1 according to the invention in its locked and hence fully operational condition, the shackle comprising a pair of first and second yoke arms 2, 3 between the free ends of which extend a shackle pin 4. A first end of the shackle pin 4 includes an integral flanged and knurled knob 5 which limits the extent to which the pin 4 can travel across the yoke arms in the axial direction. Extending into the first yoke arm 2 is a guide element 6 in the form of a detente pin, the opposite end of which is received within the common groove 10 in a manner to be explained. Extending from the first yoke arm 2 is a pushbutton 7 co-operable with a cut-out part of the knob 5 in a manner to be described. Extending outwardly from the first yoke arm 2 adjacent the pushbutton 7 is a sloped shoulder 2a which, in use, prevents or inhibits snagging of the pushbutton 7 by ropes, chains, webbing or, in the case of use of the shackle by arborists, branches of trees. The second end of the shackle pin 4 remote from the knob 5 includes a radially movable locking element 8 surrounded by a circular shoulder 9 extending from the second yoke arm 3.

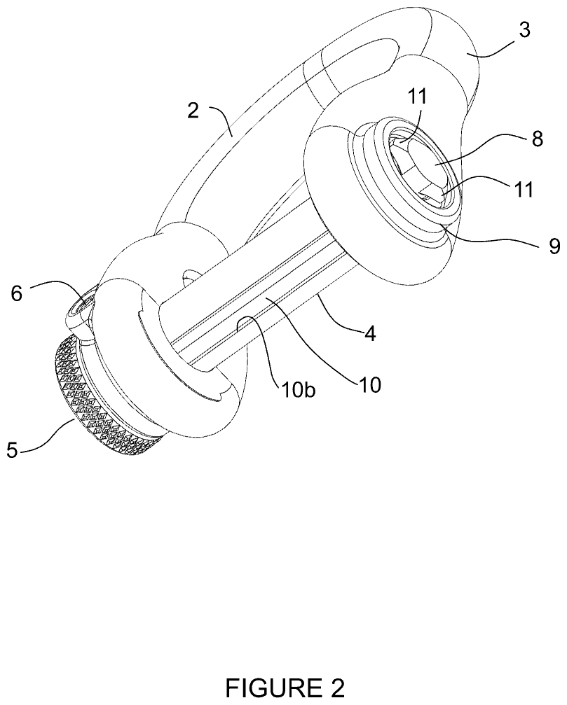

FIG. 2 shows a perspective view from the front and one side of the shackle of FIG. 1 in which it will be seen that the elongate part 10b of the common groove 10 extends axially along the shackle pin 4 although it will be understood that this part of the common groove need not be perfectly linear and could be, for example, helical. The radially movable locking element 8 at the end of the shackle pin 4 remote from the knob 5 includes a pair of oppositely-disposed key formations 11 which releasably locks the shackle pin 4 in the position shown in a manner to be described.

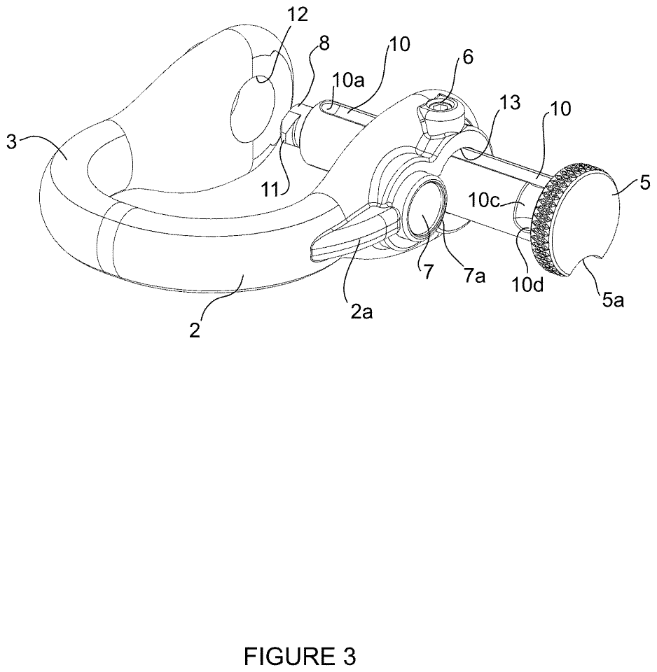

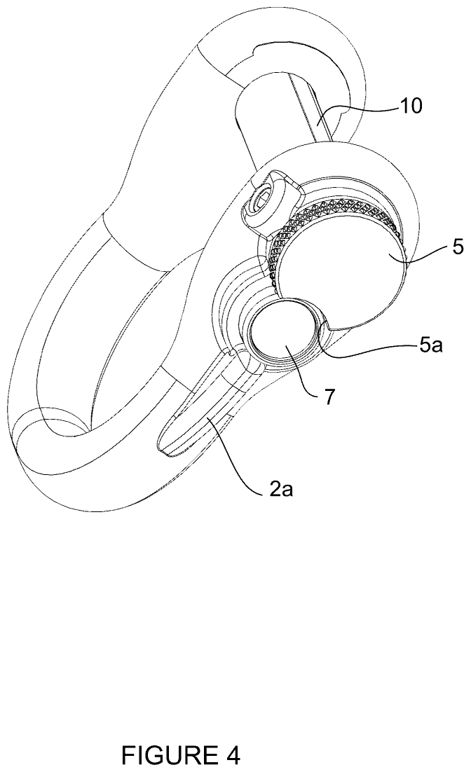

FIG. 3 shows a perspective view from the rear and one side of the shackle in its part-open condition in which it will be seen that the common groove 10 has a closed end 10a which prevents complete withdrawal of the shackle pin as a consequence of it receiving the free end of the guide or detente element 6. The linearly opposite end of the groove 10 includes a 90° bend and continues to an arcuate portion 10c also having a closed end 10d to thereby limit rotation about the major axis of the shackle pin 4. The knurled knob 5 includes a part-circular notch 5a having a curvature corresponding to the outer rim 7a around the pushbutton 7 and is engageable therewith in the manner as shown in FIG. 4 by which to also prevent rotation of the shackle pin 4 when it has been rotated through 90° such that the axially-extending part of the common groove 10 is then facing away from the base of the yoke arms 2, 3.

The second yoke arm 3 includes a bore 12 and the first yoke arm 2 includes a co-axial bore 13 permitting the shackle pin 4 to be freely slidable therewithin to the limit imposed by the closed ends 10a and 10d of the common groove 10 and associated guide element 6.

FIG. 4 is a perspective view of the shackle 1 in its fully closed and locked condition in which it will be seen that the arcuate part 5a of the knurled knob 5 has been rotated through 90° from the position shown in FIG. 3 whereby to releasably capture the pushbutton 7 to thereby prevent any rotation about the major axis of the shackle pin 4 until the pushbutton 7 is depressed to thereby disengage it from the arcuate part 5a of the knurled knob 5.

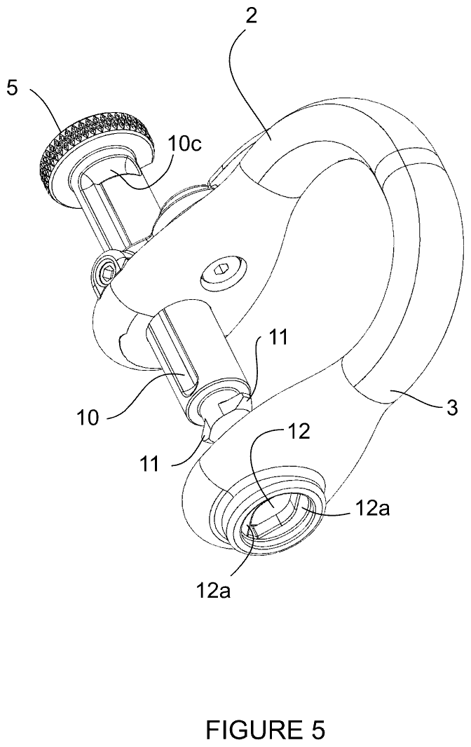

FIG. 5 is a perspective part-disassembled view from the other side of the shackle to that shown in FIG. 4 in which it will be seen that the bore 12 in the second yoke arm 3 has a partially closed end which includes a pair of oppositely-disposed lock escutcheon formations 12a of shape corresponding to the key formations 11 at the end of the shackle pin 4 remote from the knurled knob 5 such that when the knob 5 is rotated in either direction to the limit imposed by the arcuate part 10c of the common groove 10 the shackle pin can be locked and unlocked from its engagement with the second yoke arm 3.

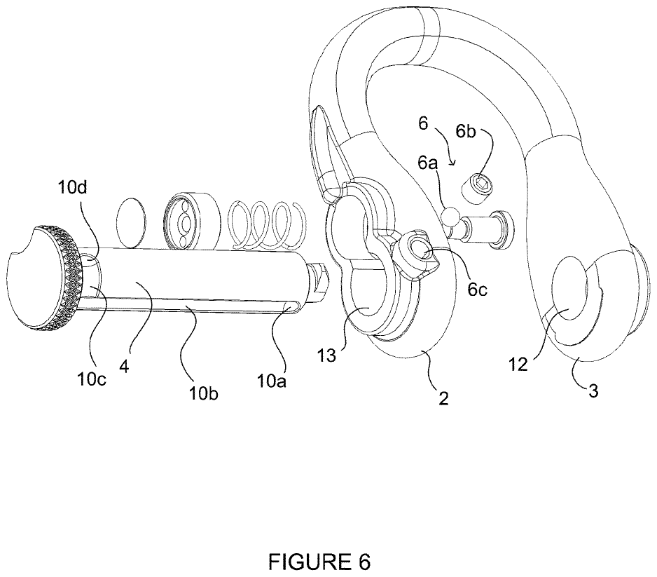

As will be seen from the exploded view shown in FIG. 6, the guide element 6 is comprised of a detente ball bearing 6a and generally cylindrical stop member 6b, the latter being of diameter corresponding to that of a bore 6c into which it can be press-fitted extending into the first yoke arm 2 at a position generally transverse to the major axis of the yoke bore 13, the generally cylindrical bore 6c having a closed end with a small bore therethrough permitting part of the ball bearing 6a to extend into and run freely along the common groove 10 in the shackle pin 4 while preventing complete removal of the shackle pin 4 by virtue of the presence of the closed end 10a of the common groove 10.

In operation, the shackle 1 is opened by pressing the pushbutton 7 to thereby release it from engagement with the cut-out portion 5a of the knurled knob 5, thereby permitting rotation of the knurled knob and hence the shackle pin 4 about its major axis until the ball bearing 6a of the guide element 6 is aligned with the axially extending part 10b of the common groove 10, thereby allowing the shackle pin 4 to be withdrawn from between the first and second yoke arms 2, 3 up to the limit imposed by the closed end 10a of the common groove 10.

Upon insertion of a coupling element between the arms of the yoke, such as the free end of a chain link, the shackle pin 4 is then slid back to its original position and rotated about its major axis to the limit imposed by the closed end 10d of the arcuate part 10c of the common groove 10, at which position the shackle pin 4 can be locked against movement about its major axis as a consequence of the outer periphery of the pushbutton 7 interfering with the cut-out portion 5a of the knurled knob 5. To lock the shackle pin 4 in this position so as to resist tensile strain when the shackle is in use the key formations 11 at the opposite end of the shackle pin 4 now lie behind the keyhole formations 12a in the bore 12 of the second yoke arm 3, thereby effectively forming a mechanically closed loop for resisting tensile loads that would otherwise try to separate the shackle pin 4 from the second yoke arm 3. Opening of the shackle 1 is accordingly achieved by the simple expedient of depressing the pushbutton 7 to release the knurled knob 5, rotating the knob through 90° and then withdrawing the shackle pin 4 to the extent permitted by the presence of the closed end 10a of the common groove 10.

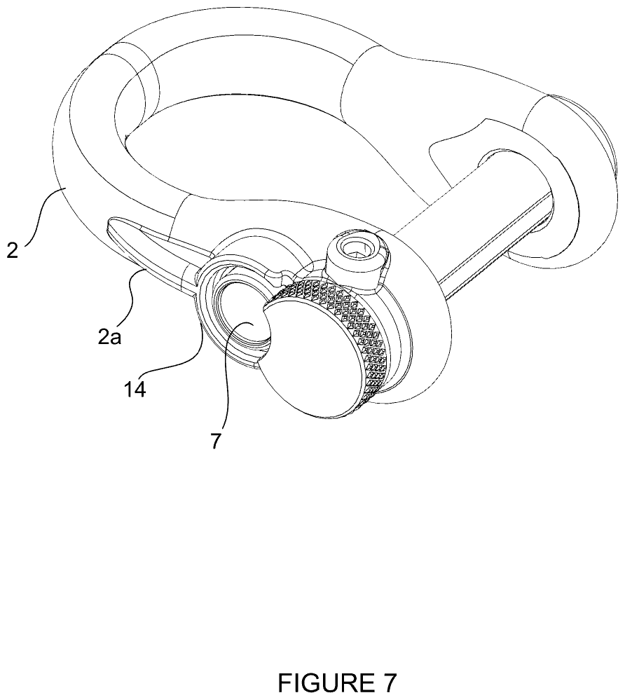

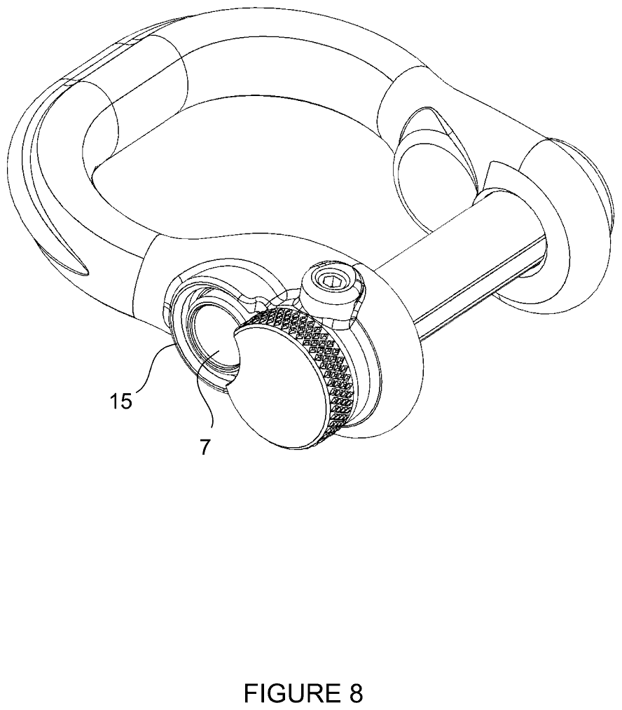

FIGS. 7 and 8 show respective first and second preferred versions of the invention in which an important safety feature is included. FIG. 7 corresponds to the embodiment shown in FIG. 4 to the extent that it includes the same sloped portion 2a extending from the yoke arm 2 leading towards the pushbutton 7, the slope tending to avoid the possibility of that part of the shackle becoming snagged, in use, with potential hazards such as ropes, chains, webbing and, in the case of arborists, branches which could potentially cause difficulties if the shackle is used as part of climbing equipment. However, it will be understood that accidental operation of the pushbutton 7 is still possible, particularly from a direction orthogonal to the major plane of the yoke arms 2,3. In order to avoid this possibility the first version of the preferred embodiments of the invention as shown in FIG. 7 includes a part-cylindrical collar 14 which surrounds the otherwise exposed circumferential portions of the pushbutton 7, thereby ensuring that it can only be operated deliberately by finger pressure. In the same way, the second version of the preferred embodiments shown in FIG. 8, which does not include the sloped portion 2a of the yoke arm 2, also has a part-cylindrical collar 15 surrounding the otherwise exposed sides of the pushbutton 7 for the same purpose.

This drawing, in particular, shows the generally simple construction of the invention in which it will be apparent that machining of the shackle yoke can be achieved primarily through drilling, with no awkward slots needing to be cut or otherwise formed, as in the case of the prior art. Although the shackle pin 4 includes the common groove 10, this is easily formed on the outside of a rod of metal due to ease of access for rotary machine tools such as milling heads and cutters if the common groove is not formed by pressing or forging where, again, such processes are relatively easily afforded. However, other forms of convenient manufacture exist including investment moulding where, essentially, the entire shackle, other than the shackle pin, can be formed in a single operation using a lost wax process, with only minimal machining thereafter being required to form e.g. perfectly aligned coaxial bores 12, 13.

In a further refinement to the invention suitable, in particular, where the shackle is to be used in a permanent or semi-permanent location the pushbutton 7 and attendant spring-loaded operating mechanism may be replaced with a more rigid arrangement such as by the use of a threaded fastener with a generally circular flanged end remote from the threads and having e.g. an hexagonal recess requiring the use of an Allen key to remove the fastener to thereafter permit rotation of the knurled knob 5 for the purposes of partially withdrawing the shackle pin 4.

The invention in its various embodiments therefore provides an elegantly simple solution to the problem of potential separation of parts of the shackle during assembly or disassembly but without any significant removal of metal from either or both of the yoke arms 2, 3. Even though there is a common groove 10 extending along most of the length of the shackle pin 4 it is a groove that can be relatively shallow because its only purpose is to guide e.g. the detente ball bearing 6a of the guide element 6 as the shackle pin 4 is moved between the yoke arms 2,3 and thereafter rotated about its major axis to the limit imposed by the closed end 10d of the common groove 10. Accordingly, the common groove 10 can be formed through light machining to remove only enough material for the purposes of ensuring that it can serve to guide the guide element 6, or it may even be pressed or forged into the shackle pin 4 such that no material is lost. By locking the shackle pin to the second yoke arm 3 through the use of an integral key and keyhole escutcheon arrangement instead of a split-pin arrangement inserted into the protruding end of a shackle pin, it ensures that no parts of the shackle can become lost, and are instead easily accessible and connectable even in inclement weather conditions. Also, because the integral key and keyhole escutcheon arrangement is disposed, in use, within the bore 12 it is not necessary for the free end of the shackle pin 4 to extend beyond it such that there are no substantial projections on that side of the shackle which could otherwise form a significant snagging hazard. On the opposite side of the shackle, even though the knurled knob 5 necessarily has to project outwardly from the side of the yoke arm 2 sufficient to allow fingers to rotate it, it can be in the form of a generally thin disc since its only function is to act as an indexing arrangement to show when the guide element 6 is at the furthest end 10d of the common groove 10, and even where a sloped shoulder 2a is provided on the first yoke arm 2 adjacent the pushbutton 7 it essentially only needs to project laterally from the yoke arm 2a by the width of the pushbutton 7 such that the risk of it becoming snagged is minimal and the respectively opposite sides of the shackle have an effectively low-profile and generally contiguous outer profile.

A further advantage of this general arrangement is that the entire width between the first and second yoke arms can be used to accommodate links or pulley wheels of the same width because when the shackle pin is fully retracted the free end of the shackle pin is received entirely within the bore 13 in the first yoke arm 2 and does not protrude into the space between the yoke arms 2, 3. This contrasts with prior art arrangements where e.g. links or couplings of significantly narrower width must be used because the full width between yoke arms is unavailable. In turn, due to the absence of any obstructions between the entire width of the yoke arms there is no tendency to snag with e.g. spliced rope as it passes over the shackle pin.

A further useful feature of the invention is the provision of the pushbutton 7 and in particular its high visibility when received in the arcuate recess 5a in the knurled knob 5, thereby clearly indicating a “locked” state for the shackle pin 4, which locked state may also be confirmed by an audible “click” as the full diameter of the pushbutton 7 becomes visible when the knob 5 is rotated to thereafter allow the pushbutton 7 to enter the arcuate recess 5a.

1. A shackle having a yoke with a pair of first and second yoke arms with respective first and second co-axial bores between which are disposed a shackle pin, the shackle pin having a flanged first end to limit axial movement through the first bore, the shackle including locking means whereby to prevent accidental release of the shackle pin from the yoke arms, a guide element extending into the shackle pin receiving bore of the first yoke arm and being received in a common groove in the outer surface of the shackle pin, the common groove having an arcuate portion with a closed first end adjacent the first end of the shackle pin, the common groove continuing radially from the closed first end to a corner portion and thereafter continuing
along the major length of the shackle pin to a closed second end adjacent the second end of the shackle pin, the second end of the shackle pin being receivable in the corresponding bore of the second yoke arm, wherein extending axially from the second
end of the shackle pin are key formations co-operable with a keyhole formation at the end of the bore in the second yoke arm whereby to prevent withdrawal of the shackle pin from the bore in the second yoke arm when the shackle pin has been rotated about its major axis such that the key formations lie behind the keyhole formation.

2. The shackle of claim 1 wherein the keyhole formation is integrally formed with the second yoke arm.

3. The shackle of claim 1 wherein the flanged first end of the shackle pin includes a peripheral notch co-operable with a locking button biased to occupy the notch whereby to prevent accidental rotation of the shackle pin about its major axis and permitting rotation of the shackle pin when the button is pushed.

4. The shackle of claim 3 wherein the peripheral notch is part circular and the locking button is at least part circular.

5. The shackle of claim 3 wherein the free end of the locking button is coloured, whereby to provide a visual indication when the shackle pin is locked.

6. The shackle of claim 1 wherein the first yoke arm includes a ramp adjacent the locking button, whereby to prevent or inhibit accidental snagging thereof in use.

7. A pulley comprising the shackle of claim 1 and a pulley wheel mounted on the shackle pin.

8. The pulley of claim 7 wherein the major length of the common groove in the shackle pin is arranged, when locked, to face away from the yoke arms, whereby to maximise the bearing surface available for the pulley wheel when under tensile load.
